(19) United States
(12) Patent Application Publication
(10) Pub. No.: US 2012/0145081 A1
(43) Pub. Date: Jun. 14, 2012

(54) Insect feeder

(76) Inventors: E. Barçin Acar, Sammamish, WA (US); David R. Burton, Sammamish, WA (US); Ted B. Ellis, Shoreline, WA (US); Emma Rae Mullen, Seattle, WA (US); David R. Nash, Arlington, WA (US); Michael Vinton, Bothell, WA (US)

(21) Appl. No.: 12/928,451

(22) Filed: Dec. 10, 2010

(51) Int. Cl. A01K 29/00

(52) U.S. Cl. 119/6.5; 119/51.01; 119/57.8; 119/57.92

(57) ABSTRACT

An insect feeder that allows membrane feeding with a membrane above a feeding medium.

### SUMMARY

In one aspect, an apparatus includes a base including a receptacle for an insect feeding medium, and a membrane support structure configured to position a membrane above the receptacle in contact with insect feeding medium. The membrane support structure is configured to allow an insect to alight upon the apparatus and feed on the medium through the membrane while the membrane is above the medium. The apparatus may also include a heater (e.g., integrated into the base or positioned within the receptacle) configured to heat insect feeding medium loaded into the receptacle. The heater may be configured to maintain the insect feeding medium at a constant temperature, or to maintain different temperatures at different portions of the receptacle. The heater and the receptacle may be configured to facilitate free convection in the insect feeding medium. The apparatus may also include a fluid transducer configured to move insect feeding medium, and the receptacle may include structures configured to direct flow of the feeding medium. The membrane support structure may be configured to position the membrane in an inclined position, for example in a position in which the membrane contacts the insect feeding medium with different pressures at different points of the membrane. The membrane support structure may be configured to stretch the membrane (e.g., uniformly), or to hold the membrane in a uniformly stretched position. The membrane support structure may include a membrane (e.g., integral to the support structure). The insect may be hemophagous (e.g., a mosquito, a tsetse fly, a louse, a bed bug, a flea, a sand fly, a midge, a snipe fly, a horse fly, a stablefly, or a sheep fly), and the apparatus may include at least one perching region for an insect.

In another aspect, a method of feeding an insect includes placing insect feeding medium into a receptacle, and placing a membrane in contact with and above the medium, the membrane being configured to be penetrated by the insect for feeding, and exposing the membrane above the feeding medium to the insect. The method may further include maintaining the insect feeding medium at a selected temperature, or maintaining a selected temperature profile within the feeding medium. The method may further include inducing convection in the feeding medium, which may be free convection or forced convection (e.g., by operating a fluid transducer). The feeding medium may include blood, albumin, whey protein, or a blood component. The insect may be hemophagous, such as a mosquito (e.g., Anopheles, Aedes, or Culex), tsetse fly, a louse, a bed bug, a flea, a sand fly, a midge, a snipe fly, a horse fly, a stablefly, or a sheep fly, or it may be an aphid, a butterfly, a moth, or a beetle.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic of an insect feeder.

FIG. 2 is a flowchart illustrating use of an insect feeder.

FIG. 3 is a disassembled view of an insect feeder.

FIG. 4 shows a membrane including a drawstring.

FIG. 5 shows a membrane attached to a support structure including tensioning support clips.

FIG. 6 is a schematic of a heating system for an insect feeder.

FIG. 7 is a schematic of a patterned heating plate for an insect feeder.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

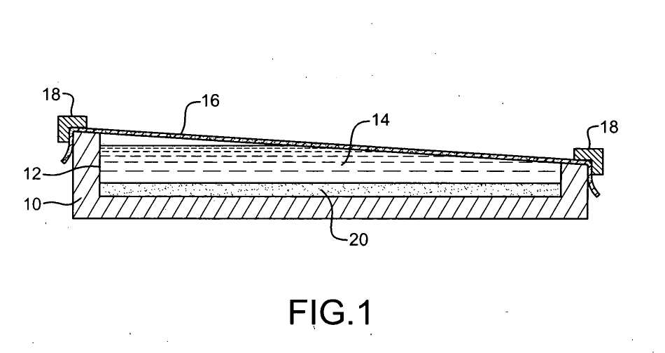

FIG. 1 is a schematic of an insect feeder. It includes base 10, which as shown includes a recessed receptacle area 12 which may be filled with insect feeding medium 14. The insect feeding medium may be a liquid, a gel, or a solid, and may include multiple phases (e.g., a sponge saturated with liquid feeding medium).

The composition of the medium may depend upon the type of insect to be fed: for example, if the feeder is used to feed mosquitoes or other hemophagous insects, the medium may include blood, blood components, or an artificial medium (e.g., the media disclosed in copending and commonly owned U.S. Application No. To be Assigned (filed on even date herewith entitled FOOD COMPOSITION FOR HEMOPHAGOUS INSECTS, naming E. Barçin Acar, Geoffrey F. Deane, 3ric Johanson, Emma Rae Mullen, Nathan P. Myhrvold, Nels R. Peterson, Clarence T. Tegreene, Charles Whitmer, and Lowell L. Wood, Jr. as inventors, which is incorporated by reference herein). If the feeder is used to feed herbivorous insects (e.g., aphids, butterflies, moths, or beetles), the medium may include nectar, sugar water, or other artificial feeding media. In general, the medium may include any insect nutrient or micronutrient suitable to its intended application (e.g., sugars, polysaccharides, amino acids, proteins such as albumin or whey protein, lipids, vitamins, hormones, or pharmaceuticals). The medium may include substances intended to attract feeding insects (e.g., pheromones, or for mosquitoes and other hemophagous insects, CO₂, lactic acid, pentyl vinyl carbinol, or isolayeric acid), to repel unwanted insects or other organisms, or to affect insects upon feeding (e.g., toxins, microorganisms, and/or parasites). Such additives may also be placed in various locations of the feeder, as further discussed below.

The feeder illustrated in FIG. 1 further includes a membrane 16 which is secured above, and in at least partial contact with, the insect feeding medium 14 by support structure 18, and an optional heater 20. Optional heater 20 is placed in thermal contact with the medium. In the embodiment illustrated in FIG. 1, the heater 20 is placed below the insect feeding medium 14.

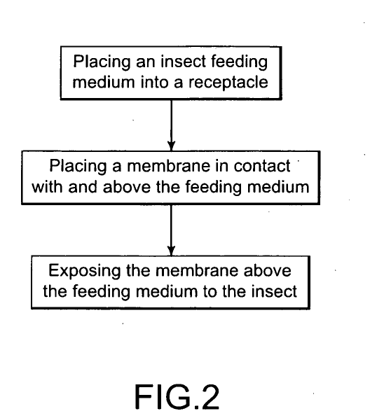

An embodiment of a method of use of the feeder is shown in flowchart form in FIG. 2. The insect feeding medium is placed in a receptacle, and the membrane is placed in contact with and above the feeding medium. (These steps may occur in any order.) The membrane over the feeding medium is exposed to an insect. The insect may land, for example on membrane 16, support structure 18, or base 10, and would penetrate membrane 16 to feed upon the insect feeding medium 14. In some embodiments, a specific perch (not shown) may be provided. In some embodiments, the insect will be one having piercing or sucking mouthparts, such as a mosquito (e.g., Anopheles, Aedes, Culex, Mansonia, Stegomyia, Aedimorphus), a tsetse fly, a louse, a bed bug, a flea, a sand fly, a midge, a snipe fly, a horse fly, a stablefly, a sheep fly, a lady beetle, a lace wing, an ant, an aphid, a butterfly, a moth, a beetle, a mealybug, a whitefly, or a scale insect. If the insect prefers to land for feeding, having the membrane placed above the feeding medium may in some embodiments encourage feeding by mimicking a natural landing surface (e.g., in the case of hemophagous insects, mimicking a body surface) or by minimizing the effort necessary to remain in the feeding position. In some embodiments, some or all feeder components can be composed of materials suitable for cleaning or sterilization, for example in an autoclave.

In some embodiments, color (or other visual features such as pattern) of one or more components of the feeder may affect insect behavior, for example by encouraging feeding or by encouraging perching in a selected area. Alternatively or in addition, the feeder may also provide chemical, auditory, visual, or other stimuli to influence behavior. For example, support structure 18 may include either integrated or as a separate component a compartment (not shown) which may contain, for example, an attractant, pheromone, kairomone, allomone, phagostimulant or repellent that would alter behavior of insects (e.g., encouraging or discouraging feeding of particular species, or of conditions such as gravid females, or encouraging crop feeding, midgut engorgement, proboscis extension, penetration, crop distention, or draw of fluid by pharyngeal pump). In some embodiments, the feeder may include a nozzle or similar structure (not shown) configured to direct CO₂ (or another appropriate additive such as the behavior-modifying substances described above) onto a surface of the feeder, membrane, or feeding medium, or to bubble CO₂ (or another appropriate additive) through the feeding medium.

In the embodiment illustrated in FIG. 1, support structure 18 is configured to support membrane 16 in a somewhat inclined position above feeding medium 14, placing the membrane in at least partial contact with medium 14. In use, this inclined position provides a pressure gradient of a fluid insect feeding medium 14 along its area of contact with membrane 16 due to the gradient fluid head along the membrane. We have observed that mosquitoes may cluster in some areas of the membrane when such a gradient exists. Without wishing to be bound by any particular theory, we believe that insects may exhibit preferences for a desired pressure of fluid, and that they may preferentially feed at regions of the membrane exhibiting their preferred pressure levels. (These preferences may or may not be constant over the life cycle of the insect.) In some embodiments, pressure levels of feeding medium 14 may be dynamically altered (e.g., increasing the area presenting a preferred pressure level, or pulsing pressure, for example to emulate a blood pulse). Such alterations may be effected by using gravity (e.g., by altering the inclination or configuration of the receptacle 12 or of membrane 16 or membrane support 18), or by use of a fluid transducer (e.g., a pump, circulator, impeller, stirrer, agitator, vibrator, or similar component). A fluid transducer may also be used in some embodiments to provide a steady or a spatially varying pressure.

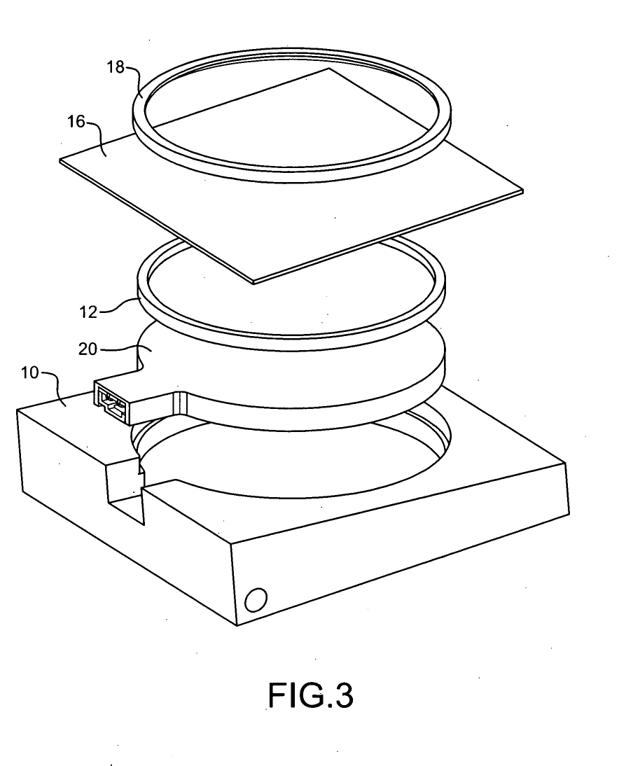

FIG. 3 illustrates an embodiment of an insect feeder in a disassembled view. In this embodiment, receptacle 12 is a separate component configured to fit into base 10, rather than a recess defined in the base as shown in FIG. 1. Illustrated support structure 18 is a ring configured to snap onto receptacle 12. Membrane 16 can be placed across support structure 18, and secured by attachment of support structure 18 to receptacle 16 in a drumhead configuration. Membrane 16 may be any membrane suitable for containing feeding medium 14 while allowing penetration for insect feeding. For example, the membrane may include, for example and without limitation, one or more of parafilm, latex, nylon, polyamide, polyalkyne, polyester, polycarbonate, polyether, polyimide, polyimine, polysulfone, polysaccharide, polyurethane, polyvinyl, polyolefin, cellophane, cellulose, skin, or gut, and may be permeable, semi-permeable (e.g., dialysis tubing), or impermeable to selected fluids. The membrane may also include components intended to attract, repel, or otherwise affect insects (e.g., pheromones, CO₂ generators, flavoring agents, toxins, microorganisms, or parasites).

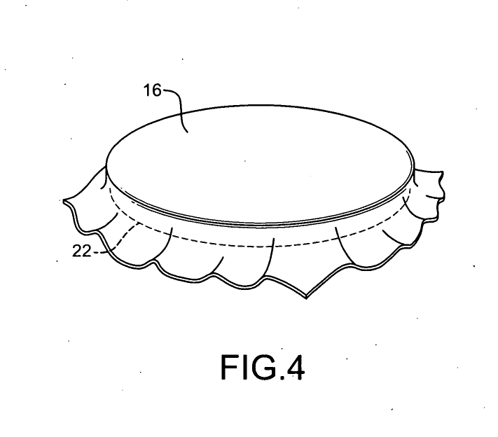

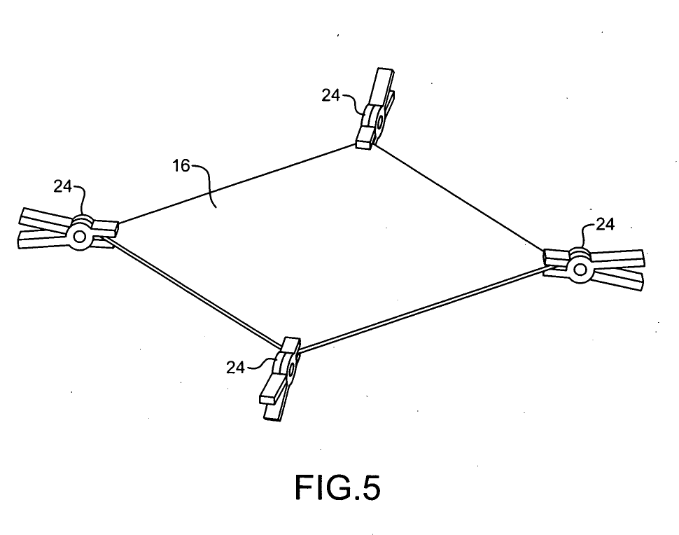

In some embodiments, membrane support structure 18 or membrane 16 may include mechanisms for evenly stretching membrane 16. For example, membrane 16 may include a drawstring 22 arrangement that allows it to be tightened uniformly around membrane support structure 18 as shown in FIG. 4, or the support may include tensioning clips 24 (e.g., nonpiercing clips such as those used for silk painting) as shown in FIG. 5. Tensioning clips may be integral to support 18, or support 18 may include retainers for securing separate clips. Hooks or other securing fasteners may also be used, rather than clips. In some embodiments, optionally including either of the arrangements of FIG. 4 or FIG. 5, elastic members may be used to provide a resilient attachment of the membrane.

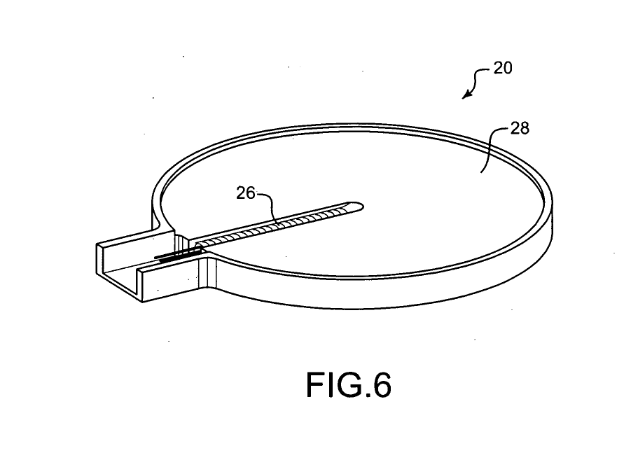

FIG. 6 is a schematic of a heater 20 for an embodiment of an insect feeder. In the illustrated embodiment, the heater includes an electric heating element 26 and a thermally conductive plate 28 (e.g., a metal plate). The plate acts to distribute heat substantially uniformly under feeding medium 14, as shown in FIG. 1 and FIG. 3. In some embodiments (not illustrated), rather than a more localized heating element, the heating element may be configured to distribute heat over conductive plate 28 (e.g., an insulated KAPTON™ heater, including an etched copper foil element of 0.0005″ or 0.0001″ thickness which is encapsulated between two layers of 0.002″ polyimide film and 0.001″ FEP adhesive). In some embodiments, the heater (and other components) may be configured to induce free convection in feeding medium 14 upon activation of the heater. In some embodiments, the feeder may also include a fluid transducer, which may induce forced convection in feeding medium 14. In some embodiments, channels or other flow-directing features may also be provided to direct convection in feeding medium 14 (e.g., a raised area in the center of receptacle area 12 configured to encourage flow of heated feeding medium from the center to the edge of the feeder). While the heaters 20 illustrated in FIG. 1 and FIG. 6 are positions below feeding medium 14, other arrangements may also be used. For example, a heater may be integrated into the sides of receptacle 12 or may be immersed in feeding medium 14. When present, a heater may be configured to maintain a constant temperature (which may vary spatially), or to maintain a dynamic temperature profile.

In some embodiments, the heater 20 may include one or more thermistors or thermocouples (not shown), for example, a thermistor positioned at the end of heating element 26, in the approximate center of plate 28. In one embodiment, a thermistor is a precision (±0.2° C.) linear, temperature-sensitive, resistive element with a negative temperature coefficient manufactured from metal oxide(s) (e.g., nickel, manganese, iron, cobalt, magnesium, titanium and other metals) and are epoxy encapsulated. In some embodiments, they may be designed for operation below 75° C. Such thermistors may be chemically stable and not significantly affected by aging or by exposure to strong fields of hard nuclear radiation. We have electrically coupled the output of such a thermistor to a controller to control the heater illustrated in FIG. 6 (including the KAPTON™ heater described above), and found that we were able to maintain our feeding medium at a temperature within ±0.5° C. of our target temperature throughout the medium (as measured by the thermistor at the center of plate 28 and by thermocouples at positions around the rim).

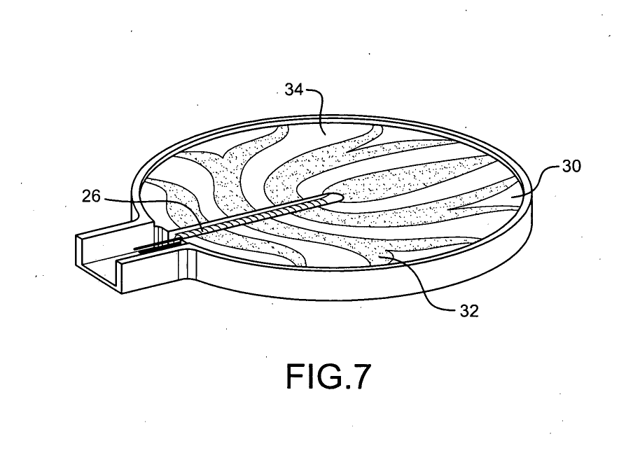

While the heater illustrated in FIG. 6 distributes heat substantially uniformly through feeding medium 14, in some embodiments, local heating of one or more areas of the medium may be desired (e.g., to induce free convection, or to mimic a pattern of veins and arteries under the skin via a pattern of warmer and cooler regions of the feeding medium surface). In some such embodiments, such local heating may be effected by substituting a patterned heating plate 30 (FIG. 7) for the thermally conductive heating plate 28 shown in FIG. 6. (In some embodiments, patterned plate 30 may be interchangeable with uniform plate 28, but interchangeability is not required.) Patterned heating plate 30 includes regions having both relatively high and relatively low thermal conductivity, conducting more heat to high conductivity regions 32 than to low conductivity regions 34. In some embodiments, “cooler” regions of the plate may be actively cooled, for example with cooling channels in the plate. The pattern chosen for patterned heating plate 30 will depend on the needs of the specific embodiment; the pattern illustrated in FIG. 7 is purely exemplary. In some embodiments (not shown), spatial variation may be provided by multiple heating elements, heat pipes, or other known methods of providing local heating.

Various embodiments of insect feeders and methods have been described herein. In general, features that have been described in connection with one particular embodiment may be used in other embodiments, unless context dictates otherwise. For example, the heating plate described in connection with FIG. 7 may be employed in the devices described in connection with FIG. 1, or with any of the embodiments described herein. For the sake of brevity, descriptions of such features have not been repeated, but will be understood to be included in the different aspects and embodiments described herein.

It will be understood that, in general, terms used herein, and especially in the appended claims, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended, such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or an (e.g., “an insect” should typically be interpreted to mean “at least one insect”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “two insects,” or “a plurality of insects,” without other modifiers, typically means at least two insects). Furthermore, in those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Moreover, “may,” “can,” “optionally,” and other permissive terms are used herein for describing optional features of various embodiments. These terms likewise describe selectable or configurable features generally, unless the context dictates otherwise.

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably coupleable” to each other to achieve the desired functionality. Specific examples of operably coupleable include but are not limited to physically mateable or interacting components or wirelessly interacting components.

While various aspects and embodiments have been disclosed herein, other aspects and embodiments will be apparent to those skilled in the art based on the teachings herein. The various aspects and embodiments disclosed herein are for purposes of illustration and are not intended to be limiting, with the true scope and spirit being indicated by the following claims.

What is claimed is:

1. An apparatus, comprising:
a base including a receptacle for an insect feeding medium; and
a membrane support structure configured to position a membrane above the receptacle in contact with insect feeding medium, wherein the membrane support structure is configured to allow an insect to alight on the apparatus and to feed on the medium through the membrane while the membrane is above the medium.

2. The apparatus of claim 1, further comprising a heater configured to heat insect feeding medium loaded in the receptacle.

3. The apparatus of claim 2, wherein the heater is integrated into the base.

4. The apparatus of claim 2, wherein the heater is positioned within the receptacle.

5. The apparatus of claim 2, wherein the heater is configured to maintain the insect feeding medium at a constant temperature.

6. The apparatus of claim 2, wherein the heater is configured to maintain different temperatures at different portions of the receptacle.

7. The apparatus of claim 2, wherein the heater and receptacle are configured to facilitate free convection in the insect feeding medium.

8. The apparatus of claim 1, further comprising a fluid transducer configured to move insect feeding medium.

9. The apparatus of claim 8, wherein the receptacle includes structures configured to direct flow of the feeding medium.

10. The apparatus of claim 1, wherein the membrane support structure is configured to position the membrane in an inclined position.

11. The apparatus of claim 10, wherein the membrane support structure is configured to position the membrane in a position in which the membrane contacts the insect feeding medium with different pressures at different points of the membrane.

12. The apparatus of claim 1, wherein the membrane support structure is configured to stretch the membrane.

13. The apparatus of claim 1, wherein the membrane support structure is configured to uniformly stretch the membrane.

14. The apparatus of claim 1, wherein the membrane support structure is configured to hold the membrane in a uniformly stretched position.

15. The apparatus of claim 1, wherein the membrane support structure includes a membrane.

16. The apparatus of claim 15, wherein the membrane is integral to the membrane support structure.

17. The apparatus of claim 1, wherein the insect is hemophagous.

18. The apparatus of claim 17, wherein the insect is selected from the group consisting of a mosquito, a tsetse fly, a louse, a bed bug, a flea, a sand fly, a midge, a snipe fly, a horse fly, a stablefly, and a sheep fly.

19. The apparatus of claim 1, further comprising at least one perching region for an insect.

20. A method of feeding an insect, comprising:
placing an insect feeding medium into a receptacle;
placing a membrane in contact with and above the feeding medium, the membrane being configured to be penetrated by the insect for feeding; and
exposing the membrane above the feeding medium to the insect.

21. The method of claim 20, further comprising maintaining the insect feeding medium at a selected temperature.

22. The method of claim 20, further comprising maintaining a selected temperature profile within the feeding medium.

23. The method of claim 20, further comprising inducing convection in the insect feeding medium.

24. The method of claim 23, wherein the convection is free convection.

25. The method of claim 23, wherein the convection is forced convection.

26. The method of claim 25, wherein inducing convection includes operating a fluid transducer.

27. The method of claim 20, wherein the insect feeding medium includes blood.

28. The method of claim 20, wherein the insect feeding medium includes albumin.

29. The method of claim 20, wherein the insect feeding medium includes whey protein.

30. The method of claim 20, wherein the insect is hemophagous.

31. The method of claim 30, wherein the insect is a mosquito.

32. The method of claim 31, wherein the mosquito is of the genus Anopheles.

33. The method of claim 31, wherein the mosquito is of the genus Aedes.

34. The method of claim 31, wherein the mosquito is of the genus Culex.

35. The method of claim 30, wherein the insect is selected from the group consisting of a tsetse fly, a louse, a bed bug, a flea, a sand fly, a midge, a snipe fly, a horse fly, a stablefly, and a sheep fly.

36. The method of claim 30, wherein the insect feeding medium includes a blood component.

37. The method of claim 20, wherein the insect is selected from the group consisting of an aphid, a butterfly, a moth, or a beetle.
